(19) United States
(12) Patent Application Publication
(10) Pub. No.: US 2010/0175760 A1
(43) Pub. Date: Jul. 15, 2010

(54) FLOAT VALVE

(76) Inventor: Graham Mansfield Stuart, Cambridge (NZ)

Correspondence Address: FAY SHARPE LLP, 1228 Euclid Avenue, 5th Floor, The Halle Building, Cleveland, OH, 44115, US

(21) Appl. No.: 12/600,969

(22) PCT Filed: May 21, 2008
(86) PCT No.: PCT/GB08/01732

§ 371 Date: Mar. 23, 2010

(30) Foreign Application Priority Data
May 21, 2007 (GB) 0709733.0

(51) Int. Cl. F16K 24/04

(52) U.S. Cl. 137/15.26; 137/202

(57) ABSTRACT

A float valve is mounted within the ullage of a liquid storage tank and is fitted to a lower end of a vapour vent line. The float valve includes a generally tubular vent body having an opening arrangement which allows vapour to escape from the tank into the vent line, and a float assembly which undergoes damped upward movement in response to the liquid level within the tank exceeding a threshold level. The float assembly comprises a sleeve and a float arrangement separated from each other by an adjustable distance. In this way, the volume of liquid required in the tank to make the float assembly move upward can be changed. The float valve may include a relief valve or a plug with a bleed orifice to permit vapour flow from the tank to the vapour vent line in the event that the pressure within the tank exceeds a predetermined value.

### FIELD OF THE INVENTION

The present invention relates to a float valve and a float assembly for use in a float valve. More specifically, the present invention relates to a float valve for use in a vapour vent line of a fuel storage tank, and to a float assembly for use in the same.

### BACKGROUND TO THE INVENTION

Float valves are widely used to cut off liquid or vapour flow from storage tanks when a volume or height of liquid therein reaches a predetermined threshold level. This is particularly useful where visual inspection of the level of liquid is impossible or otherwise impractical. Accordingly, such valves are frequently used in underground liquid fuel storage tanks. Float valves are installed inside the tank on a vapour vent line to shut off a flow of liquid into the tank automatically and to restrict a flow of vapour back to a fuel delivery vehicle when the fuel reaches the threshold level.

Simple ball float vent valves, such as Dover Corporation's OPW53 series valves, comprise a ball held within in an elongate cage. When the tank is filled to a predetermined level, the ball float rises to seat tightly against a specially designed valve seat. Such valves have historically served as a back-up for a conventional overfill prevention device (OPD) on an inlet of the fuel storage tank. However, such valves can close very suddenly and violently and generally result in generation of hydraulic shocks. Since underground tanks are often only tested for pressures of between 0.4 and 0.8 bar, transmission of hydraulic shocks can cause bursting of tanks and pipe work.

The reader is referred to GB-A-2309767, which discloses a damped float valve that closes more gradually in response to a rising fuel level within the tank. However, the damped float valve does not offer customisability for a particular user's needs.

### OBJECT OF THE INVENTION

An object of the invention is to provide a float valve that ameliorates at least some of the above-mentioned problems.

### SUMMARY OF THE INVENTION

According to a first aspect of the invention, there is provided a float valve for controlling a vent line from a liquid storage tank, the float valve comprising an elongate float assembly movable on a tubular vent body, wherein upward movement of the float assembly is damped by pressure of vapour within the tubular body, at least just prior to the valve closing onto its seat, and wherein the float assembly comprises a sleeve, a float arrangement and means for adjusting a position of the float arrangement relative to the sleeve.

The float valve comprises a pressure-balanced sleeve. The sleeve does not slide over the opening arrangement in response to an increase in positive pressure within the storage tank, but in dependence upon a fluid level within the tank. Furthermore, having a variable position of the float arrangement relative to the sleeve allows the threshold level at which the valve starts to close to be adjusted, by adjusting the height of the float arrangement above the base of the tank.

In preferred float valve according to the invention the vent body comprises a relief valve arranged to open in response to the pressure inside the tank passing a predetermined threshold level.

A pressure relief valve can prevent pressures within the tank exceeding a predetermined threshold pressure, thereby reducing the risk of rupturing the tank and/or associated pipe work. The relief valve also serves as a failsafe device in the event that float valve becomes jammed and the opening arrangement remains covered by the sleeve, by providing a path through which vapour from within the tank can escape. Furthermore, a vacuum relief valve can prevent the pressure within the tank falling below a predetermined pressure, thereby preventing a vacuum forming within the tank. In this context, “passing” can mean exceeding or falling below.

In a more preferred float valve the predetermined threshold level is adjustable. Having an adjustable float valve provides an operator with greater flexibility and can reduce the risk of rupturing the tank and/or associated pipe work by carefully choosing the pressure at which the relief valve is to open.

In a more preferred float valve the vent body comprises a plug having a bleed orifice.

Having a plug with a bleed orifice provides an escape path for vapour from within the tank in the event that the opening arrangement is fully covered or in the event that the float valve becomes jammed.

In a more preferred float valve the float assembly comprises an elongate shaft disposed between the sleeve and the float arrangement.

The elongate shaft can be used to provide a more lightweight float assembly.

In a more preferred float valve the elongate shaft is longer than the sleeve.

Having elongate shaft longer than the sleeve reduces the risk of liquid from within the tank reaching the float valve before it closes.

In a more preferred float valve the elongate shaft is at least twice as long as the sleeve portion.

This further reduces the risk of the liquid reaching the valve before it closes.

In a more preferred float valve the elongate shaft comprises indicia indicative of a volume of liquid within the tank.

The indicia enables an operator accurately to adjust the distance between the sleeve and the float assembly so that the valve starts to close at a predetermined desired fill level of the tank.

In a more preferred float valve the float arrangement comprises a closed-cell polyvinyl chloride body.

Closed-cell polyvinyl chloride has a good resistance to liquid absorption, and is generally not degraded by exposure to liquid fuels.

In a more preferred float valve the vent body comprises an opening arrangement having a triangularly shaped aperture arranged to allow vapour exchange between the interior of the tank and the vent line.

Triangularly shaped openings provide a profiled gradual closing of the valve in response to a rise in fluid level, which reduces generation of shockwaves in the tank.

In a more preferred float valve the float arrangement is slidable along the elongate shaft.

This allows for easy adjustment of the position of the float arrangement relative to the sleeve. This, in turn, means that it is easier to adjust the fill level at which the valve starts to close.

In a preferred float valve the float valve is configured to transition from an open to a closed state progressively in response to a small increase in the volume of liquid within the tank.

In a preferred float valve the small increase is about a 1% increase in the volume of liquid within the tank.

According to a second aspect of the invention, there is provided a float assembly for use in the float valve, the float assembly comprising a sleeve, a float arrangement and means for adjusting a position of the float arrangement relative to the sleeve.

According to a third aspect of the invention, there is provided a method of installing the float valve on a vent line, the method comprising providing the valve so as to be in communication with a vent line from a liquid storage tank and adjusting a position of the float arrangement relative to the sleeve. Preferably the method includes sliding the float arrangement along the elongate shaft. More preferably, the method includes adjusting the position of the float arrangement on the basis of indicia on the elongate shaft, indicative of a volume of liquid within the tank.

According to a fourth aspect of the invention, there is provided an externally installable relief cartridge for use with the float valve, whereby, when installed, at least a part of the relief cartridge is provided externally of the vent body, between the vent body and the sleeve. This can facilitate installation and/or replacement of the relief cartridge. The relief cartridge preferably comprises a pressure or vacuum relief valve.

### BRIEF DESCRIPTION OF THE DRAWINGS

Preferred embodiments of the invention will now be described, by way of example only, with reference to the accompanying drawings, in which:

FIG. 1 is a general layout of a fuel storage tank and delivery system;

FIG. 2 is a cross-sectional perspective view of a first float valve;

FIG. 3 is a transverse cross-sectional view of the first float valve shown in FIG. 2.

FIG. 4 is a perspective view of a second float valve;

FIG. 5 is cross-sectional perspective view a third float valve;

FIG. 6 is a transverse cross-sectional view of the third float valve shown in FIG. 5;

FIG. 7 is a transverse cross-sectional view of a fourth float valve comprising a plug with a bleed orifice;

FIG. 8 is a transverse cross-sectional view of an external vacuum relief valve;

FIG. 9 is a transverse cross-sectional view of the vacuum relief valve of FIG. 9 installed in a float valve;

FIG. 10 is a cross-sectional perspective view of the arrangement of FIG. 9; and

FIG. 11 is a transverse cross-sectional view of an external pressure relief valve.

### DESCRIPTION OF THE PREFERRED EMBODIMENTS

In the following description, directional terms such as “up” and “down” will be understood by a skilled person with reference to the Figures, where, for example, “up” is generally taken to mean a direction in which liquid rises within a storage tank as the tank is filled. Other directional terms will be understood accordingly.

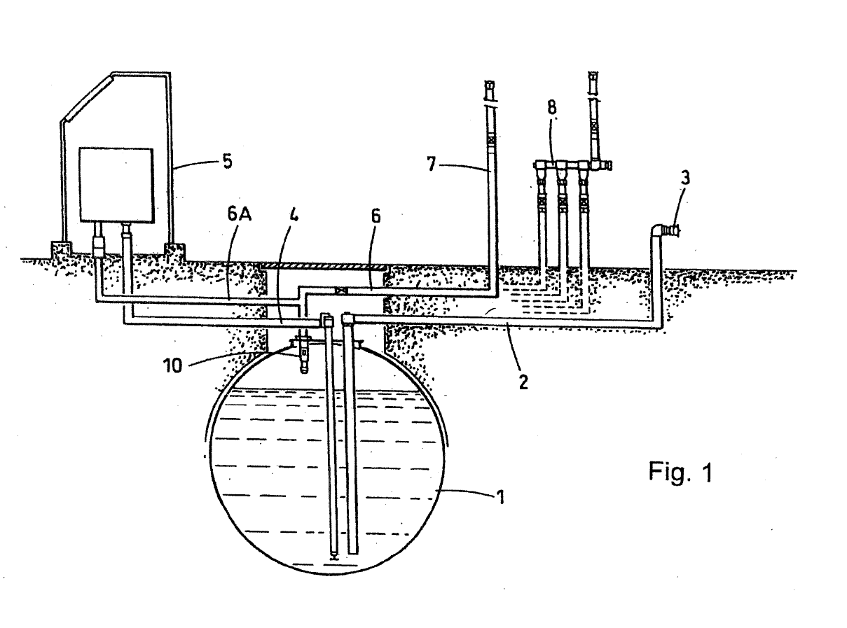

Referring to FIG. 1, a fuel storage and delivery system comprises a storage tank 1 containing a liquid, such as a liquid fuel. In this example, the tank 1 is a gravity-fill tank. The tank 1 is connected to an off-set fill line 2 (or direct fill point) through which fuel can loaded into the tank via a fuel fill point 3. Fuel from the storage tank can be delivered to a delivery pump 5 via a suction line 4. Vapour can be vented from the storage tank through a vapour vent line 6. The vapour vent line 6 may be connected either to a single vent line 7 or a vent line manifold 8, connected to several other fuel tanks (not shown). The vent line 6 may also include a branch line 6A connected to the delivery pump 5 and which is intended for vapour recovery from fuel dispensed into a vehicle.

A float valve 10 is located within the ullage, or headspace, of the tank 1 and is fitted to a lower end of the vapour vent line 6. The float valve 10 comprises a float at a lower end thereof. The valve 10 is intended to prevent vapour from within the tank 1 entering the vapour vent line 6 when fuel in the tank rises to a predetermined threshold level, so as to prevent over-filling of the tank.

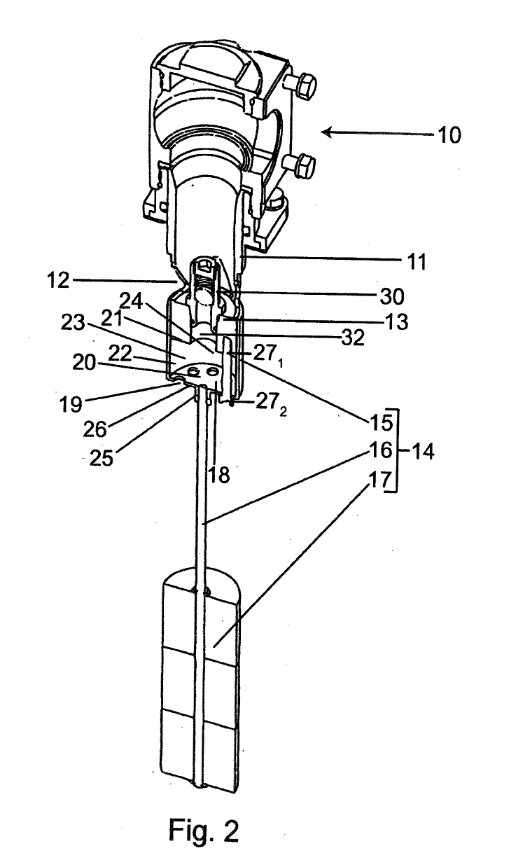

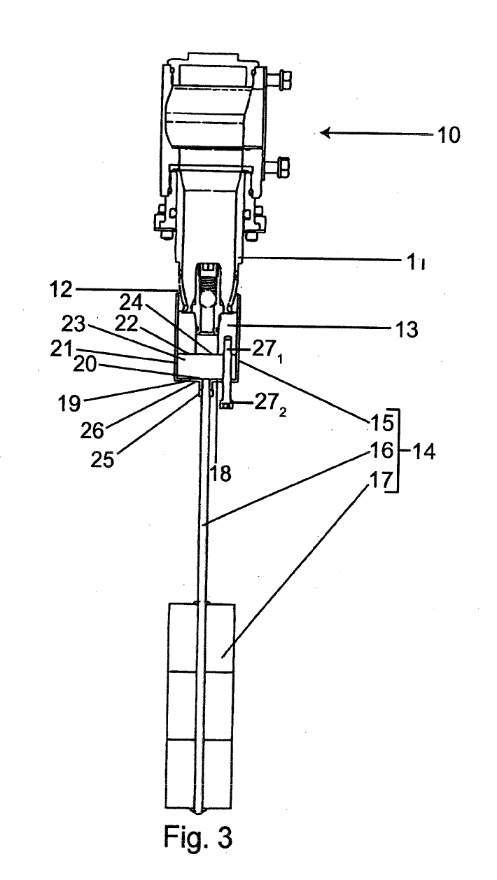

Referring to FIGS. 2 and 3, a first float valve 10 is shown. The float valve 10 comprises a generally tubular vent body 11 which, when the float valve 10 is installed, is in communication with the vapour vent line 6. The vent body 11 comprises an opening arrangement 12. In this example, the vent body 11 further comprises a generally cylindrical portion below the openings 12. The cylindrical portion 13 may be formed as a solid cylinder made of a substantially non vapour-permeable material. However, in this example, the cylindrical portion 13 has a bore 32 for receiving a relief valve 30, which will be explained in more detail later. The cylindrical portion 13 has an outer diameter d₁.

The opening arrangement 12 allows vapour to escape from the tank 1 into the vapour recovery line 6 through an interior of the vent body 11. In this example, the vapour vent valve 10 has four equally circumferentially spaced openings 12. However, it will be appreciated that a different number of openings could be used. Each opening 12 is tapered or profiled so that its width decreases in an upward direction, i.e. its width decreases in a direction away from the cylindrical portion 13. In this example, the openings 12 are triangular-shaped on the surface of the tubular vent body 11.

The float valve 10 further comprises a float assembly 14. The float assembly 14 comprises a vent body engaging portion 15, an elongate shaft 16 and a float arrangement 17.

The vent body engaging portion 15 comprises a sleeve which slides longitudinally around the cylindrical portion 13 of the vent body 11. The sleeve 15 is generally annular and has an inner diameter d₂ which is such as to fit slidably over the cylindrical portion 13 of the valve body 11. In this way, the sleeve 15 can slidably engage the cylindrical portion 13, while also minimising vapour leakage from the tank 1 between the sleeve 15 and the cylindrical portion 13. The sleeve 15 is open at an upper end and has a base 18 at a lower end thereof. One or more openings 19 are formed in the base 18. An upper face 20 of the base 18, an inner wall 21 of the sleeve 15 and a lower face 22 of the cylindrical portion 13 define a chamber 23. The lower face 22 of the cylindrical portion 13 preferably comprises a recess 24.

The rate at which vapour can escape from the tank 1 to the vapour vent line 6 depends, in part, upon the extent to which the opening arrangement 12 is uncovered. In other words, the vapour flow rate depends upon the amount or area of overlap between the opening arrangement 12 and the sleeve 15.

The elongate shaft 16 is threaded into a boss at a proximal end to a projection 25 formed on a lower face 26 of the base 18 of the sleeve 15. The elongate shaft 16 has a length l₁ which is greater than its diameter d₃. The length l₁ of the elongate shaft 16 is greater than the length l₂ of the sleeve 15, i.e. the inequality l₁>l₂ is satisfied. Preferably, the length l₁ of the elongate shaft 16 is at least twice the length l₂ of the sleeve 15, i.e. the inequality l₁>2l₂ is satisfied. For example, the length l₁ of the elongate shaft 16 may be 0.5 m and the length l₂ of the sleeve 15 may be 0.2 m.

The diameter d₃ of the elongate shaft 16 is less than each of the diameter d₁ of the cylindrical portion 13 and the diameter d₂ of the inner wall 21 of the sleeve 15, i.e. d₃<d₁ and d₃<d₂ are both satisfied.

A float arrangement 17 is carried at a distal end of the elongate shaft 16. In this example, the float arrangement 17 comprises three floats 17₁, 17₂, 17₃. However, the sensitivity of the float valve 10 can be adjusted by varying the number of floats 17₁, 17₂, 17₃. Preferably, the floats 17₁, 17₂, 17₃ comprise a closed-cell foam, such as closed-cell polyvinyl chloride (PVC) foam.

The effective length of the float arrangement 17 is adjustable by changing the position of the float arrangement 17, relative to the sleeve 15. For example, the lowermost float 17₃ may be slid up the elongate shaft 16 towards the sleeve 15 so that, in operation, a greater volume of liquid fuel is required in the tank 1 before the float assembly 14 will slide upwards. Alternatively or additionally, the elongate shaft 15 may be slidably connected to the projection 25, may be telescopic or may be arranged in another suitable way such that adjustment of the distance from the floats 17₁, 17₂, 17₃ to the base 18 is possible. Of course, the position of the float arrangement 17 may be varied relative to the sleeve 15 in many other ways.

The floats 17₁, 17₂, 17₃ can be replaced and/or supplemented by another float or floats (not shown). The other float(s) may comprise different material and/or may be structurally different to floats 17₁, 17₂, 17₃. The elongate shaft 16 and/or floats 17₁, 17₂, 17₃ may comprise markers or other indicia (not shown) to enable accurate level-setting in the case of standardised tanks 1. For example, the elongate shaft 16 may comprise indicia corresponding to a 94%, 95%, 96% and 97% fill level of the tank 1.

Preferably, the valve body 11 and the float assembly 14 are both generally cylindrical. This allows the float valve 10 to be assembled outside the tank 1 and inserted into the tank 1 via the tubular vapour vent line 6. Alternatively, the valve body 11 and the float assembly 14 need not be cylindrical, and may be installed on the vapour vent line 6 via a lid (not shown) formed in an upper wall of the storage tank 1.

The float valve 10 further comprises a peg 27₁ which is attached at a proximal end to the cylindrical portion 13 of the valve body 11. The peg 27₁ extends through one of the openings 19 in the base 18 of the sleeve 15. A radial flange 27₂ is formed at a distal end of the peg 27₁. The radial flange 27₂ abuts the lower surface 26 of the sleeve 15 so as to restrict downward vertical movement of the float assembly 14 when the level of fuel in the tank 1 falls below the threshold level. Of course, there are other means by which downward vertical movement can be restricted. For example, pins (not shown) can project radially from the cylindrical portion 13 through corresponding slots (not shown) in the sleeve 15.

During refuelling, liquid fuel is fed into the fuel storage tank 1 via the off-set fill line 2 (FIG. 1) by, for example, a delivery tanker (not shown). When the level of liquid fuel in the tank 1 rises above a height corresponding to that of the lowermost float 17₃, the float assembly 14 moves upwards, outside with sleeve 15 sliding on the cylindrical portion 13. As the sleeve 15 moves upwards, the area of the opening arrangement 12 through which vapour can escape gradually decreases from an initial value to a value close to zero, after which no further vapour can escape. In other words, the area of overlap between the opening arrangement 12 and the sleeve 15 increases from a minimum value, normally zero, to a maximum value, after which no further vapour can escape. The volume of vapour in the chamber 23 also decreases as the float arrangement 14 rises. In this way, a progressive, non-shock close action of the float valve 10 is possible, thereby reducing high peak pressures.

Preferably, the threshold level at which the float assembly 14 starts to move upwards corresponds to 96% of the volume of the tank 1 being occupied with fuel. Preferably, the opening arrangement 12 is fully closed, i.e. fully covered, when 97% of the volume of the tank 1 is occupied with fuel. Thus, the float valve 10 closes progressively and in a damped manner in response to a 1% increase in the volume of liquid within the tank. Of course, the float valve 10 can be configured to close in response to a different, small increase in volume.

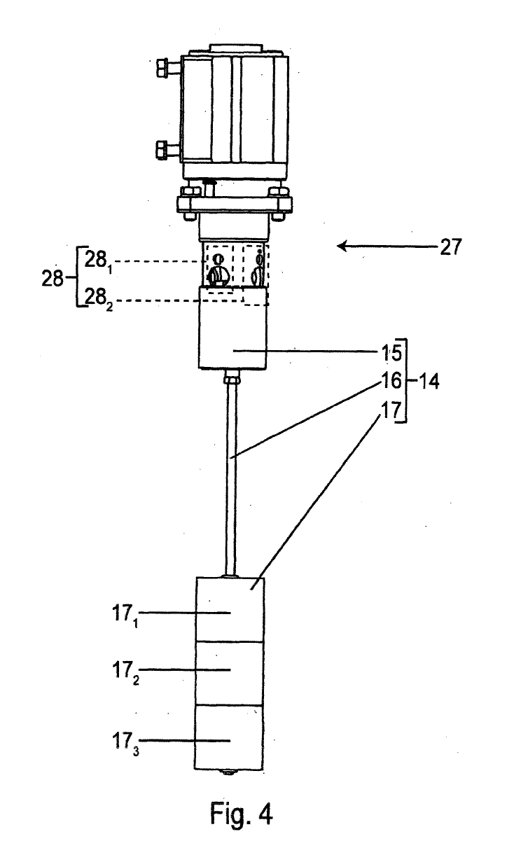

FIG. 4, shows a second type of float valve 27 according to the invention. The second float valve 27 is similar to the first float valve 10 shown in FIG. 2, with the exception of the opening arrangement 28. As explained in relation to the first float valve 10, the opening arrangement 28 is profiled so as to taper in a direction away from the cylindrical portion (hidden in FIG. 3), i.e. in a direction towards the vapour vent line 6. In this example, the opening arrangement 28 comprises first and second opening regions 28₁, 28₂, which respectively comprises sets of two and three circular apertures, decreasing in diameter in a direction towards the vapour vent line 6. Under normal operation of the float valve 27, an area of overlap between the opening arrangement 28 and the sleeve 15 increases in response to a rise in the level of liquid in the storage tank 1 above the threshold level. The shape of the opening arrangement 28 can be selected to provide a desired damping profile when the float valve 10 closes.

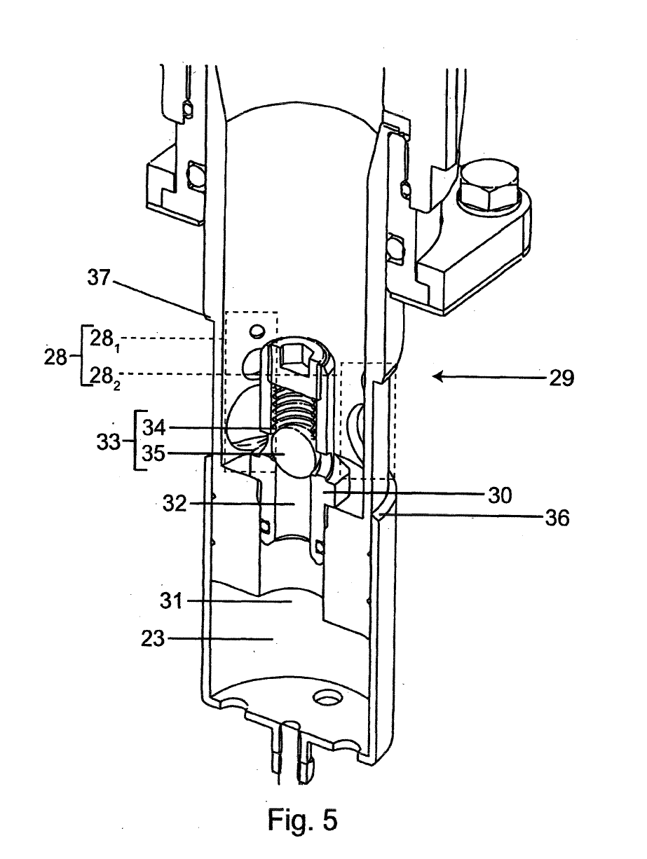

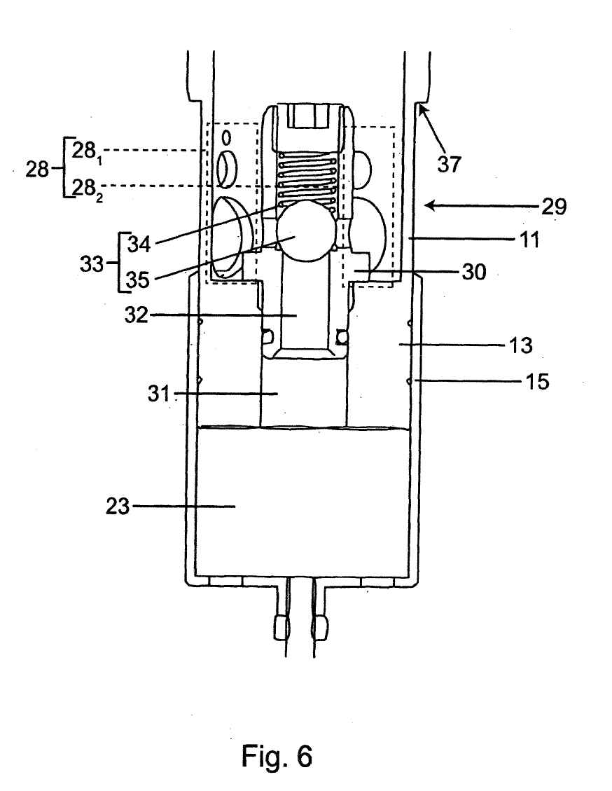

FIGS. 5 and 6, show a third type of float valve 29 according to the invention which comprises an internal pressure relief valve or cartridge 30. The relief valve 30 is provided in an upper portion of an opening 31 in the cylindrical portion 13 of the vent body 11. The relief valve 30 can be said to be ‘internal’ in that it is installed from inside the vent body 11, rather than from outside the vent body 11.

The relief valve 30 can switch between a “closed” state, which prevents vapour through-flow, or in an “open” state, which permits vapour through-flow. This could be, for example, a poppet-valve. The relief valve 30 comprises a T-shaped vapour passage 32, which allows vapour to escape from the interior of the fuel storage tank 1 via the cavity 23 to the vapour vent line 6 when the relief valve 30 is in an “open” state. The relief valve 30 also comprises means 33 responsive to a change in pressure for switching the relief valve 30 between the open and closed states. In this example, the pressure-responsive means 33 comprises a helical spring 34 and a ball 35. In the closed state, the ball 35 sits on a valve seat so as to prevent vapour communication between the interior of the tank 1 and the vapour vent line 6. When the pressure inside the tank 1 rises above a predetermined threshold level, the ball 35 is urged away from the valve seat, thereby compressing the spring 34. The relief valve 30 is then in an open state to allow vapour to escape from the interior of the tank 1. If the pressure drops below the threshold, level, the spring 34 forces the ball 35 back to its valve seat to return the relief valve 30 to the closed state.

Under normal operation, as the level of fluid inside the tank 1 increases above the threshold level, the float assembly 14 slides in the vertical direction around the valve body 11, until a rim 36 at the upper open end of the sleeve 15 abuts a corresponding flange 37 formed in the valve body 11. When the rim 36 abuts the flange 37, the opening arrangement 28 is fully covered by the sleeve 15 so that no vapour can escape into the vapour vent line 6 and the float valve 29 can be seen to be closed on its seat. However, if fuel were continued to be pumped into the tank 1 and the vapour could not escape, the pressure inside the tank would rise and could cause the tank 1 and/or associated pipe work to rupture.

When the rim 36 abuts the flange 37, the lower face 22 of the cylindrical portion 13 is spaced apart from the upper face 20 of the base 18, and the chamber 23 is thereby defined. In the event that the pressure in the tank 1 rises above the threshold value the relief valve 30 opens. Even if the openings 28 are fully covered, vapour can still escape from the interior of the tank 1, through the holes 18 in the base 19, into the cavity 23, through the T-shaped vapour passage 32 in the relief valve 30, and through the vent body 11 to the vapour vent line 6. In this way, the pressure inside the tank can be controlled so as not to exceed the threshold value, even if the openings 28 are completely closed.

The relief valve 30 serves not only to limit pressure inside the tank 1 during normal operation, but also serves as a failsafe device in the event that the float valve 29 becomes jammed and the opening arrangement 28 remains covered so that no vapour could otherwise escape. This may occur if, for example, if the float assembly 14 does not return to its lowermost position when the fuel level in the tank 1 decreases below the threshold level. However, since the relief valve 29 is arranged to open when the pressure inside the tank 1 increases above the threshold level, the pressure inside the tank can be limited or controlled accordingly.

It will be appreciated that the sensitivity, or relief factor, of the relief valve 30 can be varied so that the relief valve 30 opens at a different threshold pressure. For example, the spring 34 could have a different spring constant.

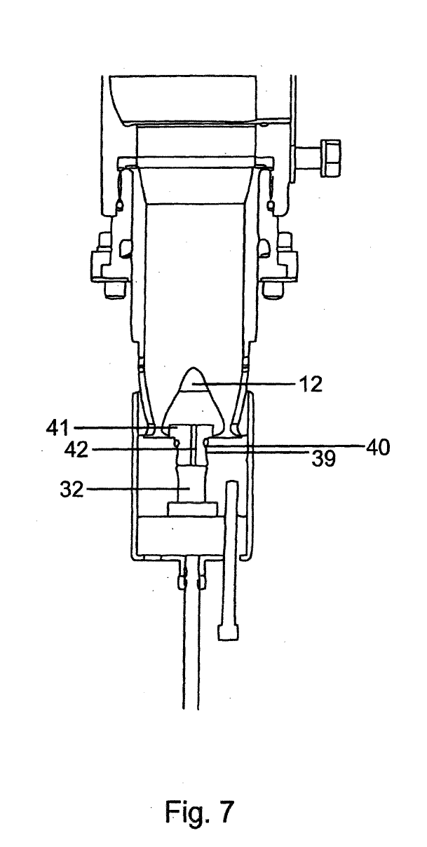

FIG. 7 shows a fourth type of float valve 38 according to the invention. The fourth float valve 38 is similar to the first, second and third float valve 29, with the exception that there is no relief valve and the bore 32 comprises an upper threaded portion 39 for receiving a corresponding threaded portion 40 of a plug 41. The plug 41 comprises a central bleed orifice 42. The bleed orifice 42 allows vapour to escape from the interior of the tank 1 when the opening arrangement 12 is fully covered.

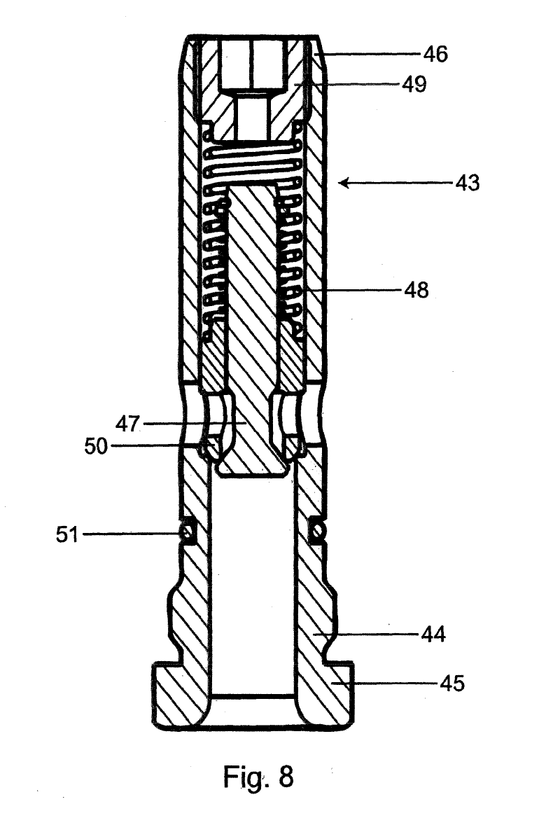

FIG. 8 shows a vacuum relief valve or cartridge 43. The cartridge 43 includes a hollowed body 44 having an enlarged head at one end 45 and a slightly tapering portion 46 at the other end. Inside the body 44, a vacuum valve 47 is connected to a spring 48 by means of a spring retainer 49. The vacuum relief cartridge 43 is shown in a closed position, whereby the vacuum valve 47 is biased towards a valve seat 50 upon which it sits. Vapour cannot pass through the vacuum relief cartridge 43 when it is closed. In an open position, the vacuum valve 47 is urged off the seat 50 by means of a negative pressure sufficient to overcome the spring 48, so as to open a vapour communication path across the cartridge 43 (i.e. between the interior of the tank 1 and the vapour vent line 6, when installed). An O-ring 51 is provided in a recess in the outer circumference of the relief cartridge 43.

The vacuum relief cartridge 43 is provided in the same location as the pressure relief valve 30 shown in FIGS. 5 and 6, but would provide the additional function of vacuum relief when the float valve is in the closed position. This would allow fuel dispensers connected to an overfilled tank 1 to operate normally and reduce the fuel level in the tank 1 until the float valve opens at a reduced fuel level. In other words, in contrast to the pressure relief valve 30 which opens in response to an increase in pressure above a threshold value, the vacuum relief valve 43 opens in response to a decrease in pressure below a threshold value, which could arise, for example, if vapour were being drawn out of the tank 1 at a greater rate than it was being provided to the tank 1.

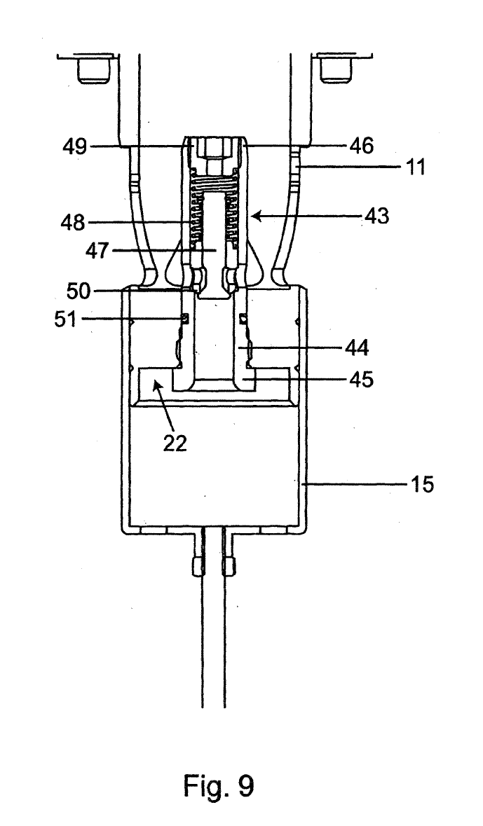

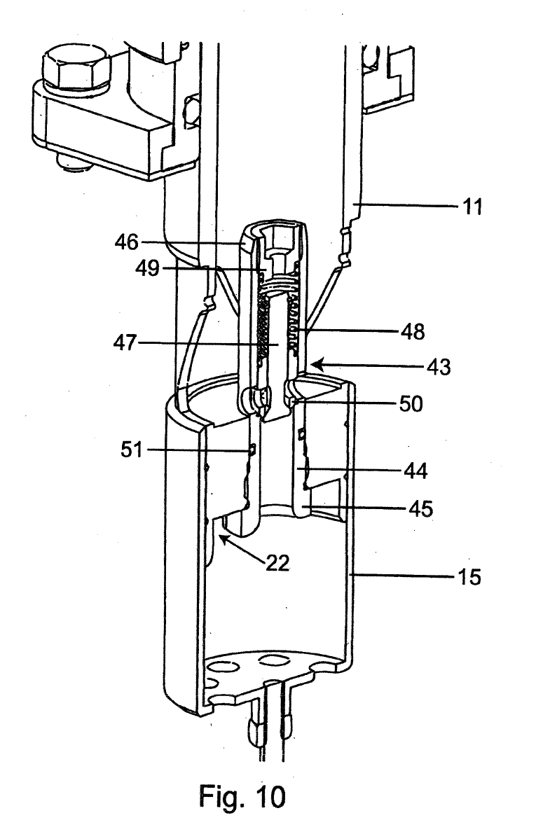

Referring to FIGS. 9 and 10, the vacuum relief cartridge or valve 43 is installed externally within the vent body 11. By “externally”, it is meant that the vacuum relief cartridge 43 is installed from the exterior of the vent body 11 rather than the interior, as is the case with the relief valve or cartridge 30 shown in FIGS. 5 and 6. When installed, the enlarged head portion 45 of the vacuum valve 44 abuts the lower face 22 of the cylindrical portion 13 of the vent body 11.

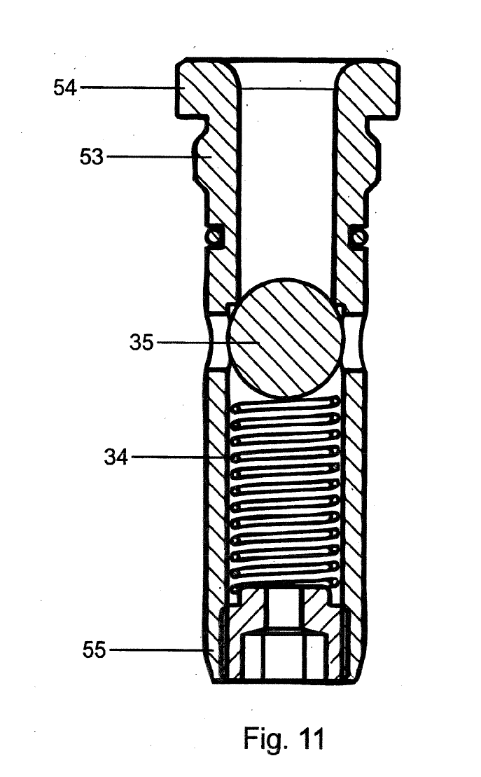

FIG. 11 shows an external pressure relief valve 52 which is similar to the pressure relief valve 30 of FIGS. 5 and 6, except that it is external in the sense that it is installed from the exterior of the vent body 11. Like the vacuum relief cartridge 43 shown in FIG. 8, the external pressure relief cartridge 52 includes a main body 53 having an enlarged head 54 at one end and a slightly tapering portion 55 at the other end. The external relief cartridge 52 can be installed from the exterior of the vent body 11 in a similar manner to the external vapour relief cartridge 43 of FIG. 8.

Various modifications may be made to the embodiments disclosed herein without departing from the scope of the invention. In particular, although the four embodiments have been described separately, it will be appreciated that features described in connection with one of them may be incorporated into another. For example, the third type of valve 29 may comprise triangular-shaped openings 12 similar to those of the first type of valve 10. Furthermore, the pressure relief valve or cartridge may be internal or external, as may be the vacuum relief valve or cartridge.

1. A float valve for controlling a vent line from a liquid storage tank, the float valve comprising an elongate float assembly movable on a tubular vent body, wherein upward movement of the float assembly is damped by pressure of vapour within the tubular body, at least just prior to the valve closing onto its seat, and wherein the float assembly comprises a sleeve, a float arrangement and means for adjusting a position of the float arrangement relative to the sleeve.

2. A float valve according to claim 1, wherein the vent body comprises a relief valve arranged to open in response to the pressure inside the tank passes a predetermined threshold level.

3. A float valve according to claim 2, wherein the predetermined threshold level is adjustable.

4. A float valve according to claim 1, wherein the vent body comprises a plug having a bleed orifice.

5. A float valve according to claim 1, wherein the float assembly comprises an elongate shaft disposed between the sleeve and the float arrangement.

6. A float valve according to claim 5, wherein the elongate shaft is longer than the sleeve.

7. A float valve according to claim 5, wherein the elongate shaft is at least twice as long as the sleeve portion.

8. A float valve according to claim 5, wherein the elongate shaft comprises indicia indicative of a volume of liquid within the tank.

9. A float valve according to claim 1, wherein the float arrangement comprises a closed-cell polyvinyl chloride body.

10. A float valve according to claim 1, wherein the vent body comprises an opening arrangement having a triangularly shaped aperture arranged to allow vapour exchange between the interior of the tank and the vent line.

11. A float valve according to claim 5, wherein the float arrangement is slidable along the elongate shaft.

12. A float valve according to claim 1, wherein the float valve is configured to transition from an open to a closed state progressively in response to a small increase in the volume of liquid within the tank.

13. A float valve according to claim 12, wherein the small increase in the volume corresponds to about a 1% increase in the volume of liquid within the tank

14. A float assembly for use in a float valve according to claim 1, the float assembly comprising a sleeve, a float arrangement and means for adjusting a position of the float arrangement relative to the sleeve.

15. An externally installable relief cartridge for use in a float valve according to claim 1, whereby, when installed, at least a part of the relief cartridge is provided externally of the vent body, between the vent body and the sleeve.

16. An external relief cartridge according to claim 15, wherein the relief valve comprises a pressure or vacuum relief valve.

17. A method of installing a float valve according to claim 1, the method comprising providing the valve so as to be in communication with a vent line from a liquid storage tank and adjusting a position of the float arrangement relative to the sleeve.

18. A method according to claim 17, comprising sliding the float arrangement along the elongate shaft.

19. A method according to claim 17, comprising adjusting the position of the float arrangement on the basis of indicia on the elongate shaft, indicative of a volume of liquid within the tank.

20. (canceled)
